(19) United States
(12) Patent Application Publication
(10) Pub. No.: US 2026/0124570 A1
(43) Pub. Date: May 7, 2026

(54) HONEYCOMB FILTER

(71) Applicant: NGK INSULATORS, LTD., Nagoya-Shi (JP)

(72) Inventors: Yuta NAKAGOSHI, Nagoya-Shi (JP); Fumihiko YOSHIOKA, Novi, MI (US); Kyohei KATO, Novi, MI (US); Ren KASUGA, Frankfurt am Main (DE)

(73) Assignee: NGK INSULATORS, LTD., Nagoya-Shi (JP)

(21) Appl. No.: 19/363,863

(22) Filed: Oct. 21, 2025

(30) Foreign Application Priority Data
Nov. 1, 2024 (JP) 2024-192860

(51) Int. Cl. B01D 46/24; B01D 53/86

(52) U.S. Cl. CPC B01D 46/2429; B01D 46/247; B01D 46/2482; B01D 46/2484; B01D 46/249; B01D 53/86; B01D 2258/01

(57) ABSTRACT

A honeycomb filter includes a pillar-shaped honeycomb structure body having a porous partition wall arranged to surround a plurality of cells and a plugging portion, wherein the sectional shape of inflow cells is octagonal and the sectional shape of outflow cells is quadrangular, the area ratio of a sectional area of the outflow cell to the sectional area of the inflow cell is 1.60-1.90, in the honeycomb structure body, the central part of the section orthogonal to the extending direction of the cells is composed of a cell straight region in which the cells extend in a straight line and the outer periphery of the section is composed of a cell curvature region in which the cells extend in a curved manner, and the percentage of the ratio of the curvature height of the cell curvature region to the total length of the honeycomb structure body is 1.00-3.00%.

This application claims the benefit of priority from the prior Japanese Patent Application No. 2024-192860, filed on Nov. 1, 2024, the entire contents of which are incorporated herein by reference.

### TECHNICAL FIELD

The present invention relates to a honeycomb filter. More specifically, the present invention relates to a honeycomb filter which can effectively suppress the increase in pressure loss when particulate matter such as soot adheres to the surface of a partition wall and achieve excellent purification performance when loaded with an exhaust gas purifying catalyst.

### DESCRIPTION OF RELATED ART

Conventionally, a honeycomb filter using a honeycomb structure has been known as a filter for trapping particulate matter in exhaust gas emitted from an internal combustion engine such as an automobile engine, or a device for purifying toxic gas components such as CO, HC, and NOx (see Patent Document 1). The honeycomb structure includes a partition wall made of porous ceramics such as cordierite and a plurality of cells defined by the partition wall. A honeycomb filter includes such a honeycomb structure provided with plugging portions so as to plug the open ends on the inflow end face side and the outflow end face side of the plurality of cells alternately. In other words, the honeycomb filter has a structure in which inflow cells having the inflow end face side open and the outflow end face side plugged and outflow cells having the inflow end face side plugged and the outflow end face side open are arranged alternately with the partition wall therebetween. In the honeycomb filter, the porous partition wall serves as a filter for trapping the particulate matter in exhaust gas. Hereinafter, the particulate matter contained in exhaust gas may be referred to as “PM”. The “PM” is an abbreviation for “Particulate Matter”.

Exhaust gas is purified by a honeycomb filter as follows. First, the honeycomb filter is disposed such that the inflow end face side is positioned on the upstream side of an exhaust system through which exhaust gas is emitted. The exhaust gas flows into inflow cells from the inflow end face side of the honeycomb filter. Then, the exhaust gas that has flowed into the inflow cells passes through a porous partition wall, flows toward outflow cells, and is emitted from the outflow end face of the honeycomb filter.

When PM in the exhaust gas is continuously removed by the honeycomb filter, PM such as soot accumulates inside the honeycomb filter, reducing the purification efficiency and increasing the pressure loss of the honeycomb filter. Therefore, for example, in purification devices using the honeycomb filter, a “regeneration process” is performed to burn PM that has accumulated inside the honeycomb filter.
[Patent document 1] International Publication WO 2006/095835

A honeycomb filter used to purify exhaust gas emitted from engines of automobiles and the like has a problem that pressure loss increases due to adhesion of particulate matter such as soot on the surface of the partition wall. Therefore, there is a demand for the development of a honeycomb filter that can suppress the increase in pressure loss.

For example, as one of the measures for reducing pressure loss, studies have been conducted on “thinner walls” to reduce the thickness of the partition walls of a honeycomb filter. However, reducing the thickness of the partition wall causes a decrease in trapping performance of the honeycomb filter. In addition, when the thickness of the partition wall is reduced, the heat capacity of the entire honeycomb filter becomes lower, and the honeycomb filter is more easily damaged in the regeneration process as described above. On the other hand, increasing the thickness of the partition wall increases the pressure loss of the honeycomb filter and increases the mass of the honeycomb filter, which leads to a deterioration in catalytic performance (in other words, purification performance) of the exhaust gas purifying catalyst loaded on the honeycomb filter.

### SUMMARY OF THE INVENTION

The present invention was made in view of the problems with the prior arts described above. The present invention provides a honeycomb filter that can effectively suppress the increase in pressure loss when particulate matter such as soot adheres to the surface of the partition wall, and can achieve excellent purification performance when loaded with an exhaust gas purifying catalyst.

According to the present invention, a honeycomb filter described below is provided.

[1] A honeycomb filter including: a pillar-shaped honeycomb structure body having a porous partition wall arranged so as to surround a plurality of cells which serve as fluid through channels extending from an inflow end face to an outflow end face; and a plugging portion disposed so as to plug an end on either the inflow end face side or the outflow end face side of the cells, wherein
the cells having the plugging portion at ends on the outflow end face side and that are open on the inflow end face side are inflow cells,
the cells having the plugging portion at ends on the inflow end face side and that are open on the outflow end face side are outflow cells,
in a section orthogonal to the extending direction of the cells of the honeycomb structure body, the sectional shape of the inflow cells is octagonal and the sectional shape of the outflow cells is quadrangular, except for the cells disposed at the outermost circumference of the honeycomb structure body,
the area ratio (S1/S2) of a sectional area S2 of the outflow cell having a quadrangular sectional shape to the sectional area S1 of the inflow cell having an octagonal sectional shape is 1.60 to 1.90,
in the honeycomb structure body, the central part of the section orthogonal to the extending direction of the cells is composed of a cell straight region in which the cells extend in a straight line from the inflow end face to the outflow end face, and the outer periphery of the section is composed of a cell curvature region in which the cells extend in a curved manner toward the outer peripheral side in the midway part from the inflow end face to the outflow end face,
the length of the honeycomb structure body from the inflow end face to the outflow end face is defined as the total length L,
the distance to the extreme point of curvature toward the outer peripheral side of the cell curvature region starting from the boundary between the cell straight region and the cell curvature region is defined as the curvature height h, and the percentage of the ratio of the curvature height h of the cell curvature region to the total length L of the honeycomb structure body (h/L×100%) is 1.00 to 3.00%.

[2] The honeycomb filter according to [1], wherein a thickness of the partition wall is 0.17 to 0.36 mm.

[3] The honeycomb filter according to [1] or [2], wherein a cell density of the honeycomb structure body is 30 to 63 cells/cm².

The honeycomb filter of the present invention effectively suppresses the increase in pressure loss when particulate matter such as soot adheres to the surface of the partition wall, and achieves excellent purification performance when loaded with an exhaust gas purifying catalyst.

### BRIEF DESCRIPTION OF THE DRAWINGS

FIG. 1 is a perspective view schematically showing one embodiment of the honeycomb filter of the present invention.

FIG. 2 is a plan view showing an inflow end face side of the honeycomb filter shown in FIG. 1.

FIG. 3 is a plan view showing an outflow end face side of the honeycomb filter shown in FIG. 1.

FIG. 4 is an enlarged plan view of a part of the inflow end face side of the honeycomb filter shown in FIG. 2.

FIG. 5 is a sectional view schematically showing a section taken along the line A-A′ of FIG. 2.

### DETAILED DESCRIPTION

The following will describe embodiments of the present invention; however, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter:

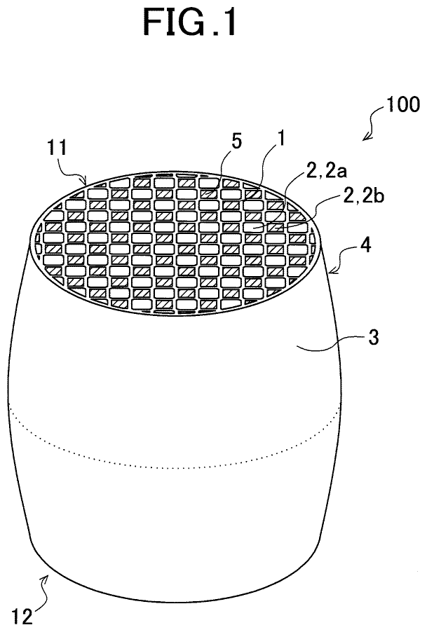

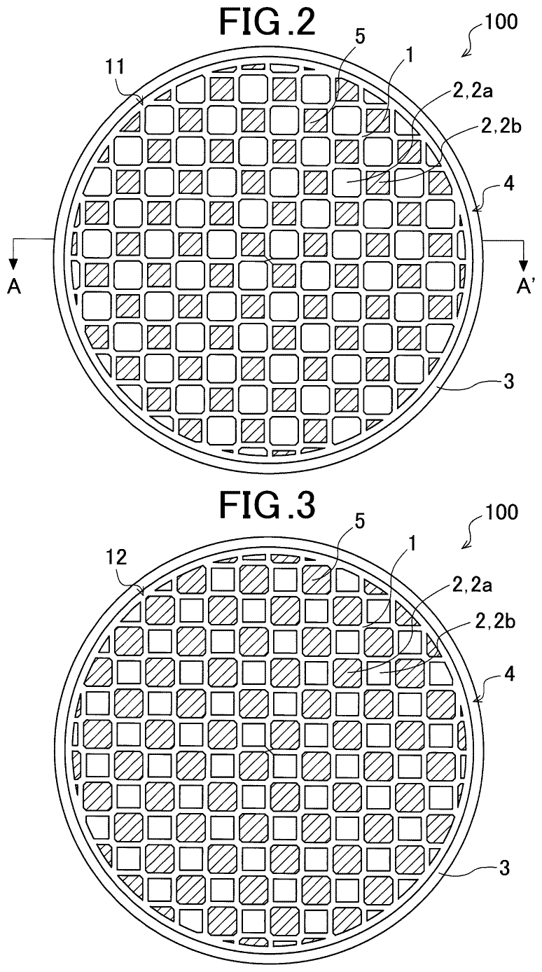

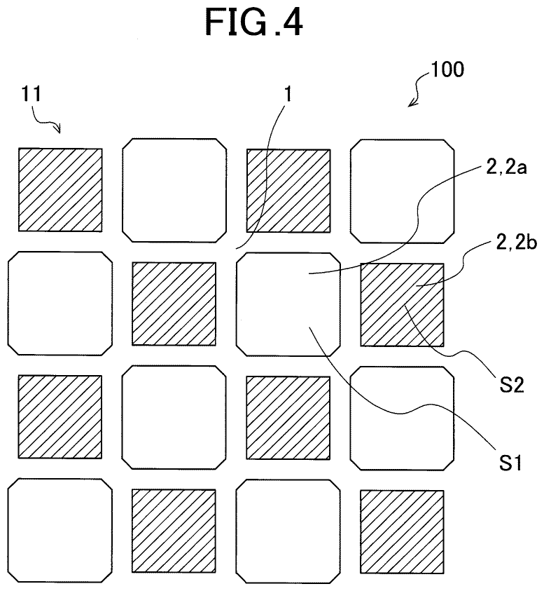

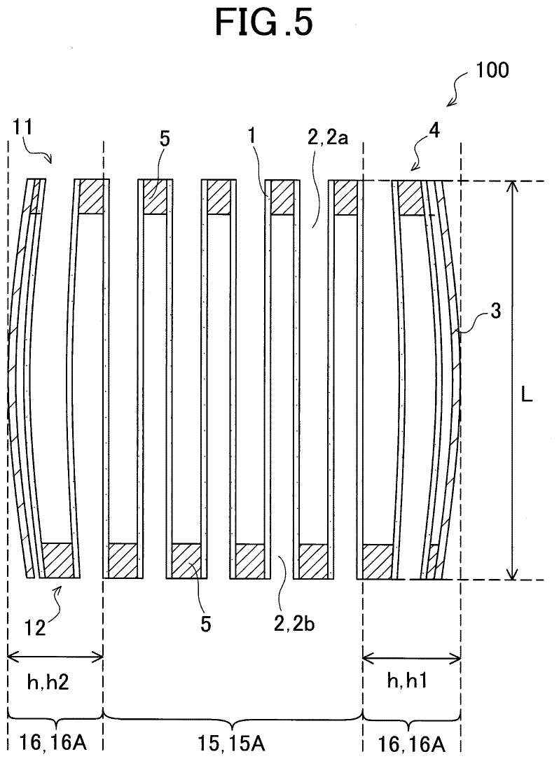

One embodiment of the honeycomb filter of the present invention is a honeycomb filter 100 shown in FIGS. 1 to 5. Here, FIG. 1 is a perspective view schematically showing one embodiment of the honeycomb filter of the present invention. FIG. 2 is a plan view showing an inflow end face side of the honeycomb filter shown in FIG. 1. FIG. 3 is a plan view showing an outflow end face side of the honeycomb filter shown in FIG. 1. FIG. 4 is an enlarged plan view of a part of the inflow end face side of the honeycomb filter shown in FIG. 2. FIG. 5 is a sectional view schematically showing a section taken along the line A-A′ of FIG. 2.

As shown in FIGS. 1 to 5, the honeycomb filter 100 includes a honeycomb structure body 4 and a plugging portion 5. The honeycomb structure body 4 has a porous partition wall 1 disposed to as to surround a plurality of cells 2 which serve as fluid through channels extending from the inflow end face 11 to the outflow end face 12. The honeycomb structure body 4 is a structure having an inflow end face 11 and an outflow end face 12 as both end faces. In the present invention, the cell 2 refers to a space surrounded by the partition wall 1. The honeycomb structure body 4 constituting the honeycomb filter 100 further has a circumferential wall 3 disposed so as to encompass the partition wall 1 on the outer peripheral side surface.

The plugging portion 5 is disposed at either an end on the inflow end face 11 side or an end on the outflow end face 12 of side of the cells 2 to plug open end of the cells 2. The plugging portion 5 is a porous thing (i.e., a porous body) composed of a porous material. In the honeycomb filter 100 shown in FIGS. 1 to 5, the predetermined cells 2 in which the plugging portion 5 is disposed at the end of the inflow end face 11 side and the remaining cells 2 in which the plugging portion 5 is disposed at the end of the outflow end face 12 side are arranged alternately with the partition wall 1 therebetween. Hereinafter, the cells 2 in which the plugging portion 5 is disposed at the end of the inflow end face 11 side will be referred to as “the outflow cells 2b”. The cell 2 in which the plugging portion 5 is disposed at the end of the outflow end face 12 side will be referred to as “the inflow cells 2a”.

In the honeycomb filter 100, in a section orthogonal to the extending direction of the cells 2 of the honeycomb structure body 4, the sectional shape of the inflow cells 2a is octagonal and the sectional shape of the outflow cells 2b is quadrangular, except for the cells 2 disposed at the outermost circumference of the honeycomb structure body 4. Hereinafter, a cell 2 whose periphery is surrounded only by the partition wall 1 is sometimes referred to as a “complete cell”. On the other hand, when a circumferential wall 3 is disposed on the outer peripheral side surface of the honeycomb structure body 4, the cell 2 disposed at the outermost circumference of the honeycomb structure body 4 (hereinafter simply referred to as “the outermost circumferential cell 2”) is the cell 2 surrounded by the partition wall 1 and the circumferential wall 3. In the outermost circumferential cell 2, a part of the periphery of the cell 2 is defined by the circumferential wall 3, making it an incomplete cell 2, like a part of the complete cell missing. Such a cell 2 whose periphery is surrounded by the partition wall 1 and the circumferential wall 3 is sometimes referred to as an “incomplete cell,” and such incomplete cells shall not be included in the cells 2 constituting the inflow cell 2a and the outflow cell 2b, as described above. Therefore, unless otherwise specified, when we simply refer to the “inflow cell 2a” and the “outflow cell 2b,” we mean the “inflow cell 2a” and the “outflow cell 2b,” which are complete cells.

The honeycomb filter 100 of the present embodiment has main characteristics, especially in the sectional shapes of the inflow cell 2a and the outflow cell 2b and their sectional areas, and the shape of the cell 2 from the inflow end face 11 to the outflow end face 12 of the honeycomb structure body 4. That is, the honeycomb filter 100 of the present embodiment first has an area ratio (S1/S2) of a sectional area S2 of the outflow cell 2b having a quadrangular sectional shape to the sectional area S1 of the inflow cell 2a having an octagonal sectional shape is 1.60 to 1.90

In addition, in the honeycomb structure body 4 constituting the honeycomb filter 100, the central part 15 of the section orthogonal to the extending direction of the cells 2 is composed of a cell straight region 15A in which the cells 2 extends in a straight line from the inflow end face 11 to the outflow end face 12. On the other hand, the outer periphery 16 of the honeycomb structure body 4 in the above section is composed of a cell curvature region 16A in which the cells 2 extend in a curved manner toward the outer peripheral side in the midway part from the inflow end face 11 to the outflow end face 12. The length from the inflow end face 11 to the outflow end face 12 of the honeycomb structure body 4 is defined as the total length L. The distance to the extreme point of curvature toward the outer peripheral side of the cell curvature region 16A starting from the boundary between the cell straight region 15A and the cell curvature region 16A is defined as the curvature height h (h1, h2). In the honeycomb filter 100 of the present embodiment, the percentage of the ratio of the curvature height h of the cell curvature region 16A to the total length L of the honeycomb structure body 4 (h/L×100%) is 1.00 to 3.00%.

The honeycomb filter 100 of the present embodiment configured as described above can effectively suppress the increase in pressure loss when particulate matter such as soot (hereinafter also referred to as “PM”) adheres to the surface of the partition wall 1, and can achieve excellent purification performance when loaded with an exhaust gas purification catalyst. That is, by curving the cell 2 at the outer periphery 16 of the honeycomb structure body 4, the surface area of the cell 2 is increased, thereby improving the purification performance by the catalyst. In addition, the increase in the surface area of the cell 2 at the outer periphery 16, as described above, also slows the increase in pressure loss when PM adheres, effectively suppressing the increase in pressure loss.

Furthermore, in the cell curvature region 16A where the cell 2 in the outer periphery 16 is curved, the maximum temperature in the regeneration process for combustion removal of PM is lower, because the thickness of the PM deposited layer in which PM is deposited is relatively thin. Therefore, damage to the honeycomb filter 100 during the regeneration process can be effectively suppressed, and the filter has excellent thermal shock resistance. The following will describe in more detail the configuration of the honeycomb filter 100 of the present embodiment.

An inflow cell 2a has an octagonal sectional shape, and an outflow cell 2b has a quadrangular sectional shape. Hereinafter, the “sectional shape” of the inflow cell 2a and the outflow cell 2b is referred to as a “cell shape”. The cell shape of the inflow cell 2a and the outflow cell 2b may include each polygon (an octagon and a quadrangle) having a curved corner, for example, a substantially quadrangular shape with curved corners of the quadrangle. When the cell shape of the outflow cell 2b is “quadrangular” and the cell shape of the inflow cell 2a is “octagonal”, the cell shape of the inflow cell 2a should be an “octagon” composed as follows. That is, the cell shape of the inflow cell 2a should be the “octagon,” which is composed by enlarging the length of one side of the quadrangle that is the cell shape of the outflow cell 2b by a specified length and chamfering the four corners of the enlarged quadrangle.

The area ratio (S1/S2) of the sectional area S2 of the outflow cell 2b to the sectional area S1 of the inflow cell 2a is 1.60 to 1.90. When the area ratio (S1/S2) is less than 1.60, the pressure loss during soot deposition increases. On the other hand, when the area ratio (S1/S2) exceeds 1.90, the pressure loss before soot deposition increases. The area ratio (S1/S2) is preferably 1.60 to 1.85, and more preferably 1.60 to 1.80.

The sectional area S1 of the inflow cell 2a and the sectional area S2 of the outflow cell 2b can be measured by analyzing the images obtained by observing with a scanning electron microscope (SEM) or microscope. The sectional area S1 of the inflow cell 2a and the sectional area S2 of the outflow cell 2b are measured at 10 arbitrarily selected locations and averaged for each.

In the honeycomb structure body 4, a central part 15 of the section orthogonal to the extending direction of the cells 2 is composed of a cell straight region 15A in which the cells 2 extends in a straight line, and an outer periphery 16 of the above section is composed of a cell curvature region 16A in which the cells 2 extend in a curved manner toward the outer peripheral side. The cell straight region 15A is distinguished from a region where the difference between the distance between the partition walls near the end faces and the distance between the partition walls near the center of the total length direction is less than 0.1 mm, and the cell curvature region 16A is distinguished from a region where the difference between the distance between the partition walls near the end faces and the distance between the partition walls near the center of the total length direction is 0.1 mm or greater.

After defining the boundary between the cell straight region 15A and the cell curvature region 16A as described above, the distance to the extreme point of curvature toward the outer peripheral side of the cell curvature region 16A starting from the boundary (curvature height h (h1, h2)) is measured in the following manner. Specifically, the filter diameter is measured at 18 locations every 20 degrees near the center of the total length direction, and the filter is cut orthogonally to the extending direction of cells 2 at the section with the largest diameter. After defining the boundary between the cell straight region 15A and the cell curvature region 16A on the cut surface as described above, the distance to the extreme point of curvature toward the outer circumference of the cell curvature region 16A (curvature height h (h1, h2)) is measured on the cut surface.

Apart from the measurement of the curvature height h (h1, h2) described above, the length (total length L) from the inflow end face 11 to the outflow end face 12 of the honeycomb structure body 4 is also measured. Then, from the measured curvature height h (h1, h2) and total length L, the percentage of the ratio of the curvature height h of the cell curvature region 16A to the total length L of the honeycomb structure body 4 (h/L×100%) is calculated. In the honeycomb filter 100 of the present embodiment, the percentage of the ratio of the curvature height h of the cell curvature region 16A described above is 1.00 to 3.00%.

Hereinafter, “the percentage of the ratio of the curvature height h of the cell curvature region 16A to the total length L of the honeycomb structure body 4” is simply referred to as “the ratio of the curvature height h (%)”.

The ratio of the curvature height h (%) of the cell curvature region 16A is not particularly limited as long as it is 1.00 to 3.00%. If the ratio of the curvature height h (%) is less than 1.00%, each of the previously described effects may not be fully realized. On the other hand, if the ratio of the curvature height h (%) exceeds 3.00%, it is not preferable in terms of isostatic strength, which is the strength of the filter itself. The ratio of the curvature height h (%) is preferably, for example, 1.10 to 3.00%, and more preferably 1.10 to 2.90%.

In the honeycomb filter 100, the configuration of the honeycomb structure body 4 having a porous partition wall 1 is not particularly limited. However, the preferred embodiments of the honeycomb structure body 4 are as follows.

In the honeycomb structure body 4, the thickness of the partition wall 1 is preferably 0.17 to 0.36 mm, and more preferably 0.20 to 0.30 mm. The thickness of the partition wall 1 can be measured using, for example, a scanning electron microscope or a microscope. If the thickness of the partition wall 1 is less than 0.17 mm, sufficient strength may not be obtained. On the other hand, if the thickness of the partition wall 1 exceeds 0.36 mm, the pressure loss of the honeycomb filter 100 may increase.

In the honeycomb structure body 4, the porosity of the partition wall 1 is preferably 45 to 65%, and more preferably 50 to 65%. The porosity of the partition wall 1 is a value measured by the mercury press-in method. The porosity of the partition wall 1 can be measured using, for example, Autopore 9500 (trade name) manufactured by Micromeritics. To measure the porosity of the partition wall 1, a part of the partition wall 1 is cut out from the honeycomb structure body 4 to obtain a sample piece, and the sample piece thus obtained can be used. The porosity of the partition wall 1 is preferably a constant value throughout the honeycomb structure body 4.

In the honeycomb structure body 4, a cell density of the cell 2 defined by the partition wall 1 is preferably 30 to 63 cells/cm², and more preferably 35 to 63 cells/cm². With this configuration, it is possible to suppress an increase in pressure loss while maintaining the trapping performance of the honeycomb filter 100.

The circumferential wall 3 of the honeycomb structure body 4 may be formed integrally with the partition wall 1, or may be a circumferential coating layer formed by applying a circumferential coating material to the outer peripheral side of the partition wall 1. For example, although not shown, the circumferential coating layer can be provided on the outer peripheral side of the partition wall after the partition wall and the circumferential wall are integrally formed and then the formed circumferential wall is removed by a known method, such as grinding, at the time of manufacturing.

The shape of the honeycomb structure body 4 is not particularly limited. The shape of the honeycomb structure body 4 is preferably a barrel-shape in which a portion extending from the inflow end face 11 to the outflow end face 12 bulges toward the outer peripheral side. The shape of the inflow end face 11 and outflow end face 12 of the honeycomb structure body 4 can be, for example, circular or elliptical.

The size of the honeycomb structure body 4, for example, the length from the inflow end face 11 to the outflow end face 12 (total length L), or the size of a section orthogonal to the extending direction of the cells 2 of the honeycomb structure body 4, is not particularly limited. Each size may be selected as appropriate such that optimum purification performance is obtained when the honeycomb filter 100 is used as a filter for purifying exhaust gas.

The material of the partition wall 1 is not particularly limited. For example, as the material of the partition wall 1, a material containing at least one selected from the group consisting of silicon carbide, cordierite, silicon-silicon carbide composite material, cordierite-silicon carbide composite material, silicon nitride, mullite, alumina and aluminum titanate can be exemplified. The material constituting the partition wall 1 is preferably a material containing 90% by mass or more of the materials listed in the above group, is further preferably a material containing 92% by mass or more of the materials listed in the above group, and is particularly preferably a material containing 95% by mass or more of the materials listed in the above group. The silicon-silicon carbide composite material is a composite material formed using silicon carbide as an aggregate and silicon as a bonding material. The cordierite-silicon carbide composite material is a composite material formed using silicon carbide as an aggregate and cordierite as a bonding material.

The material of the plugging portion 5 is preferably a material that is preferred as the material for the partition wall 1. The material of the plugging portion 5 and the material of the partition wall 1 may be the same material or different materials.

In the honeycomb filter 100, the partition wall defining the plurality of cells 2 is preferably loaded with a catalyst for purifying exhaust gas. Loading the partition wall 1 with a catalyst refers to coating the catalyst onto the surface of the partition wall 1 and the inner walls of the pores formed in the partition wall 1. This configuration makes it possible to turn CO, NOx, HC, and the like in exhaust gas into harmless substances by catalytic reaction. In addition, the oxidation of PM such as trapped soot can be accelerated. In the honeycomb filter 100 of the present embodiment, it is particularly preferable that the catalyst is loaded inside the pores of the porous partition wall 1. With this configuration, it is possible to achieve both improvement in trapping performance and reduction in pressure loss after loading the catalyst at low catalyst amount. Furthermore, after loading the catalyst, the flow of gases becomes uniform, so that the purification performance can be expected to be improved.

The catalyst with which the partition wall 1 is loaded is not particularly limited. For example, a catalyst containing a platinum group element and containing an oxide of at least one element among aluminum, zirconium, and cerium can be exemplified.

### (2) Manufacturing Method of Honeycomb Filter:

The manufacturing method of the honeycomb filter of the present invention is not particularly limited, and for example, the following methods can be used. First, a plastic kneaded material is prepared for making a honeycomb structure body. The kneaded material for making honeycomb structure body can be prepared by adding an additive such as a binder, pore former, and water, as appropriate, to a material selected from the above-mentioned suitable materials for the partition wall as a raw material powder.

Next, the kneaded material thus obtained is subjected to extrusion so as to make a pillar-shaped honeycomb formed body having a partition wall defining a plurality of cells and a circumferential wall disposed to encompass the partition wall. In the extrusion, a die in which a slit of an inverted shape of the honeycomb formed body to be formed is provided on the extruded surface of the kneaded material can be used as the die for extrusion. As the die for extrusion, a die with a slit that allows octagonal cells and quadrangular cells to be arranged alternately with the partition wall therebetween in the honeycomb formed body to be formed is used. For the size of octagonal cells and quadrangular cells, the size of each cell is adjusted so that the area ratio (S1′/S2′) between the octagonal cell area S1′ and the quadrangular cell area S2′ is 1.60 to 1.90.

By increasing the supplied amount of the kneaded material at the outer periphery compared to the central part during the extrusion, the overall shape of the honeycomb formed body is deformed to be a barrel-shape in which a portion extending from one end face to the other end face bulges toward the outer peripheral side. In this way, the shape of the honeycomb formed body is adjusted so that the percentage of the ratio of the curvature height h′ of the cell curvature region at the outer periphery of the honeycomb formed body to the total length L′ of the honeycomb formed body (h′/L′×100%) is 1.00 to 3.00%.

Next, the obtained honeycomb formed body is dried by, for example, microwave and hot air. Next, plugging portions are disposed on open ends of the cells of the dried honeycomb formed body. Specifically, for example, a plugging material containing raw materials for forming a plugging portion is prepared at first. Next, the inflow end face of the honeycomb formed body is masked so that the inflow cells are covered. Next, open ends of the unmasked outflow cells on the inflow end face side of the honeycomb formed body are filled with the previously prepared plugging material. Then, the outflow end face of the honeycomb formed body is also filled with the plugging material at the open ends of the inflow cells in the same manner as described above.

Next, a honeycomb formed body in which plugging portions have been provided on one open end of the cells is fired to manufacture a honeycomb filter. The firing temperature and the firing atmosphere differ according to the raw material, and one skilled in the art can select the firing temperature and the firing atmosphere that are the most suitable for the selected material.

### EXAMPLES

The following will describe the present invention more specifically by examples, but the present invention is not at all limited by these examples.

### Example 1

A kneaded material is prepared by adding 2 parts by mass of pore former, 2 parts by mass of dispersing medium, and 7 parts by mass of organic binder to 100 parts by mass of cordierite forming raw material, followed by mixing and kneading. As the cordierite forming raw material, alumina, aluminum hydroxide, kaolin, talc, and silica were used. As the dispersing medium, water was used. As the organic binder, methylcellulose was used. As the dispersing agent, dextrin was used. As the pore former, water absorptive polymer having an average particle diameter of 20 μm was used. In the example, the average particle diameter is the particle diameter at an integrated value of 50% (D50) in the particle size distribution determined by the laser diffraction and scattering method.

Next, the kneaded material was extruded using a die for making a honeycomb formed body. At this time, the extrusion port of the molding machine was extended radially and a die with a diameter smaller than that of the extrusion port was used. By using such a die and increasing the supplied amount of the kneaded material to the outer periphery of the die compared to the supplied amount of the kneaded material to the central part of the die, the outer periphery was rolled inward, resulting in a barrel-shaped honeycomb formed body. The shapes of the cells in the honeycomb formed body were octagonal and quadrangular, and such octagonal cells and quadrangular cells were arranged alternately with the partition wall therebetween.

Next, the honeycomb formed body was dried by a microwave dryer, and was further dried completely by a hot air dryer, and then both end faces of the honeycomb formed body were cut so as to have predetermined dimensions.

Next, a plugging material for forming a plugging portion was prepared. Specifically, water and a binder or the like are added to a ceramic raw material to prepare a slurry plugging material. Thereafter, the plugging material was used to form plugging portions in open ends of the predetermined cells on the inflow end face side and open ends of the residual cells on the outflow end face side of the dried honeycomb formed body. The plugging portions were formed so that the cells having an octagonal cell shape served as inflow cells and the cells having a quadrangular cell shape served as outflow cells.

Next, the honeycomb formed body on which each plugging portion was formed was degreased and fired to manufacture the honeycomb filter of Example 1.

The honeycomb filter of Example 1 had a cylindrical shape in which an inflow end face and an outflow end face had circular shapes. The diameters of the inflow and outflow end faces were 191 mm. Further, a length in the extending direction of cells of the honeycomb filter (total length L) was 165 mm. In the honeycomb filter of Example 1, the cell shape (sectional shape) of the inflow cell was octagonal and the cell shape (sectional shape) of the outflow cell was quadrangular. In addition, the thickness of the partition wall was 0.23 mm, the cell density was 40 cells/cm², and the porosity of the partition wall was 60%. The porosity of the partition wall was measured using Autopore 9500 (product name) by Micromeritics. The results are shown in Table 1.

The sectional area S1 of the inflow cell and the sectional area S2 of the outflow cell were measured by making observations using a scanning electron microscope (SEM) or microscope and analyzing the images obtained. The area ratio (S1/S2) of the sectional area S2 of the outflow cell to the sectional area S1 of the inflow cell was calculated based on the measured results. The calculated area ratio (S1/S2) of the cell was 1.61. The results are shown in Table 1.

In the honeycomb filter of Example 1, the central part of a section orthogonal to the extending direction of cells of the honeycomb structure body was composed of a cell straight region in which the cells extend in a straight line from the inflow end face to the outflow end face. In the honeycomb filter of Example 1, the outer periphery of the honeycomb structure body in the above section was composed of a cell curvature region in which the cells extend in a curved manner toward the peripheral side in the midway part from the inflow end face to the outflow end face. In the honeycomb filter of Example 1, the percentage of the ratio of the curvature height h of the cell curvature region to the total length L of the honeycomb structure body (h/L×100%) was 1.82%. The results are shown in Table 1.

TABLE 1

| | | | | Ratio of | | | | |
|---|---|---|---|---|---|---|---|---|
| | Sectional | Sectional | Area | curvature height | Partition | | Pressure | |
| | shape of | shape of | ratio | h of cell | wall | Cell | loss | Purification |
| | inflow | outflow | of cell | curvature region | thickness | density | with soot | performance |
| | cell | cell | (S1/S2) | (h/L × 100%) | (mm) | (cells/cm²) | Evaluation | Evaluation |
| Comparative | Octagonal | Quadrangular | 1.73 | 0.00% | 0.30 | 47 | Reference | Reference |
| Example 1 | | | | | | | | |
| Comparative | Quadrangular | Quadrangular | 1.00 | 2.97% | 0.30 | 47 | Fail | Acceptable |
| Example 2 | | | | | | | | |
| Comparative | Octagonal | Quadrangular | 1.59 | 1.21% | 0.24 | 39 | Fail | Acceptable |
| Example 3 | | | | | | | | |
| Comparative | Octagonal | Quadrangular | 1.78 | 0.97% | 0.36 | 47 | Acceptable | Fail |
| Example 4 | | | | | | | | |
| Comparative | Octagonal | Quadrangular | 1.61 | 3.03% | 0.30 | 37 | Fail | Acceptable |
| Example 5 | | | | | | | | |
| Example 1 | Octagonal | Quadrangular | 1.61 | 1.82% | 0.23 | 40 | Acceptable | Good |
| Example 2 | Octagonal | Quadrangular | 1.73 | 1.70% | 0.30 | 47 | Good | Good |
| Example 3 | Octagonal | Quadrangular | 1.71 | 1.18% | 0.25 | 62 | Excellent | Good |
| Example 4 | Octagonal | Quadrangular | 1.72 | 2.90% | 0.24 | 50 | Excellent | Excellent |

The honeycomb filter of Example 1 was evaluated for “pressure loss with soot” and “purification performance” by the following methods. Table 1 shows each result. [Pressure loss with soot]

Exhaust gas from 6.7 L diesel engine was allowed to flow into the honeycomb filters of each Example and Comparative Example, and the soot in exhaust gas was trapped at the partition wall of the honeycomb filter. The soot trapping was performed until the soot deposition amount per unit volume (1 L) of the honeycomb filter was 3 g/L. Then, when the soot deposition amount was 3 g/L, engine exhaust gas at 200° C. was allowed to flow in at a flow rate of 5.6 m³/min, and the pressures on the inflow end face side and the outflow end face side of the honeycomb filter were measured. The pressure loss (kPa) of the honeycomb filter was then determined by calculating the pressure difference between the inflow end face side and the outflow end face side. Then the pressure loss ratio (%) of each honeycomb filter was calculated when the value of the pressure loss of the honeycomb filter of Comparative Example 1 was defined as 100%, and the honeycomb filter of each Example and Comparative Example was evaluated based on the following evaluation criteria. In the following evaluation criteria, “Pressure loss ratio (%)” refers to the ratio (%) of the pressure loss of each honeycomb filter when the value of the pressure loss of the honeycomb filter in Comparative Example 1 is defined as 100%.

Evaluation “Excellent”: If the pressure loss ratio (%) is 90% or less, the evaluation is determined as “Excellent”.

Evaluation “Good”: If the pressure loss ratio (%) is greater than 90% and 95% or less, the evaluation is determined as “Good”.

Evaluation “Acceptable”: If the pressure loss ratio (%) is greater than 95% and 100% or less, the evaluation is determined as “Acceptable”.

Evaluation “Fail”: If the pressure loss ratio (%) exceeds 100%, the evaluation is determined as “Fail”.

### [Purification Performance]

First, a test gas containing NOx was flowed through the honeycomb filter. The amount of NOx in the gas discharged from the filter was then analyzed with a gas analyzer. The honeycomb temperature of the test gas flowing into the honeycomb filter was set at 200° C. The honeycomb filter and the test gas were temperature-controlled by a heater. The heater was an infrared imaging furnace. For the test gas, a gas in which 5% by volume of carbon dioxide, 14% by volume of oxygen, 350 ppm nitric oxide (by volume), 350 ppm ammonia (by volume), and 10% by volume of water were mixed with nitrogen was used. As for the test gas, water and a mix gas mixed with other gases were prepared separately, and these were mixed in a pipe and used when the test was conducted.

As the gas analyzer, “MEXA9100EGR (trade name) manufactured by HORIBA, Ltd” was used. The space velocity at which the test gas flowed into the honeycomb filter was 100,000 (hr⁻¹). The NOx purification rate of the honeycomb filter was measured from the amount of NOx in the test gas and the amount of NOx in the gas emitted from the honeycomb filter. The purification performance was evaluated from the NOx purification rate of the honeycomb filter in each Example and Comparative Example using the following evaluation criteria.

Evaluation “Excellent”: When the NOx purification rate of the honeycomb filter in Comparative Example 1 is defined as 100%, if the NOx purification rate of the honeycomb filter to be evaluated is 107.5% or higher, the evaluation is determined as “Excellent”.

Evaluation “Good”: When the NOx purification rate of the honeycomb filter in Comparative Example 1 is defined as 100%, if the NOx purification rate of the honeycomb filter to be evaluated is 102.5% or higher and less than 107.5%, the evaluation is determined as “Good”.

Evaluation “Acceptable”: When the NOx purification rate of the honeycomb filter in Comparative Example 1 is defined as 100%, if the NOx purification rate of the honeycomb filter to be evaluated is 100% or higher and less than 102.5%, the evaluation is determined as “Acceptable”.

Evaluation “Fail”: When the NOx purification rate of the honeycomb filter of Comparative Example 1 is defined as 100%, if the NOx purification rate of the honeycomb filter to be evaluated is less than 100%, the evaluation is determined as “Fail”.

### Examples 2 to 4 and Comparative Examples 1 to 5

The honeycomb filters were manufactured in the same manner as the honeycomb filter in Example 1, except that the configuration of the honeycomb filter was changed as shown in Table 1.

The honeycomb filters of Examples 2 to 4 and Comparative Examples 1 to 5 were also evaluated for “Pressure loss with soot” and “Purification Performance” in the same manner as in

### Example 1. Table 1 Shows Each Result

### Result

It was confirmed that the honeycomb filters of Examples 1 to 4 exceeded the respective performance of the reference honeycomb filter of Comparative Example 1 in the evaluation of the pressure loss with soot and the purification performance. On the other hand, the honeycomb filters of Comparative Examples 2 to 5 had inferior evaluation results of the pressure loss with soot or the purification performance compared to the honeycomb filters of Examples 1 to 5.

### INDUSTRIAL APPLICABILITY

The honeycomb filter of the present invention can be used as a filter to trap particulate matter in exhaust gas.

### DESCRIPTION OF REFERENCE NUMERALS

1: partition wall, 2: cell, 2a: inflow cell, 2b: outflow cell, 3: circumferential wall, 4: honeycomb structure body, 5: plugging portion, 11: inflow end face, 12: outflow end face, 15: central part, 15A: cell straight region, 16: outer periphery, 16A: cell curvature region, 100: honeycomb filter, h, h1, h2: curvature height, L: total length, S1, S2: sectional area (sectional area of cells).

1. A honeycomb filter comprising: a pillar-shaped honeycomb structure body having a porous partition wall arranged so as to surround a plurality of cells which serve as fluid through channels extending from an inflow end face to an outflow end face; and a plugging portion disposed so as to plug an end on either the inflow end face side or the outflow end face side of the cells, wherein
the cells having the plugging portion at ends on the outflow end face side and that are open on the inflow end face side are inflow cells,
the cells having the plugging portion at ends on the inflow end face side and that are open on the outflow end face side are outflow cells,
in a section orthogonal to the extending direction of the cells of the honeycomb structure body, the sectional shape of the inflow cells is octagonal and the sectional shape of the outflow cells is quadrangular, except for the cells disposed at the outermost circumference of the honeycomb structure body,
the area ratio (S1/S2) of a sectional area S2 of the outflow cell having a quadrangular sectional shape to the sectional area S1 of the inflow cell having an octagonal sectional shape is 1.60 to 1.90,
in the honeycomb structure body, the central part of the section orthogonal to the extending direction of the cells is composed of a cell straight region in which the cells extend in a straight line from the inflow end face to the outflow end face, and the outer periphery of the section is composed of a cell curvature region in which the cells extend in a curved manner toward the outer peripheral side in the midway part from the inflow end face to the outflow end face,
the length of the honeycomb structure body from the inflow end face to the outflow end face is defined as the total length L,
the distance to the extreme point of curvature toward the outer peripheral side of the cell curvature region starting from the boundary between the cell straight region and the cell curvature region is defined as the curvature height h, and
the percentage of the ratio of the curvature height h of the cell curvature region to the total length L of the honeycomb structure body (h/L×100%) is 1.00 to 3.00%.

2. The honeycomb filter according to claim 1, wherein a thickness of the partition wall is 0.17 to 0.36 mm.

3. The honeycomb filter according to claim 1, wherein a cell density of the honeycomb structure body is 30 to 63 cells/cm².
